(19) United States
(12) Patent Application Publication
(10) Pub. No.: US 2011/0016216 A1
(43) Pub. Date: Jan. 20, 2011

(54) Optimized negotiation of coding resources between communication clients

(76) Inventors: Olivier Durecu, Nozay (FR); Bruno Legat, Nozay (FR)

Correspondence Address: HARNESS, DICKEY & PIERCE, P.L.C., P.O. BOX 8910, RESTON, VA, 20195, US

(21) Appl. No.: 12/736,286

(22) PCT Filed: Apr. 10, 2009
(86) PCT No.: PCT/FR2009/050663

§ 371 Date: Sep. 27, 2010

(30) Foreign Application Priority Data
Apr. 24, 2008 (FR) 0852752

(51) Int. Cl. G06F 15/16

(52) U.S. Cl. 709/227

(57) ABSTRACT

A network (N) device (S) (I_{SA}, I_{SB}) for transmitting signalling messages between a calling client (A) and a called client (B), which may contain resource information regarding the coding resources that these clients have, and intended to establish a communication session between said clients. It has means (MT) for deleting the information contained within a message of invitation received from the calling client before transmission to the called client, to determine a set of usable resources from the resource information contained within that message of invitation and within the answer message received from the called client, and to select, if need be, a coding resource from among that set and insert information about that resource as the only information within the answer message received from the called client before transmission to the calling client, and within the message of acknowledgment received from the calling client before transmission to the called client.

The present invention concerns the negotiation of coding resources between two communication clients for the transmission of a multimedia session.

It applies in particular, but not exclusively, to “IMS” (“IP Multimedia Subsystem”) communication architectures specified by the standardization bodies 3GPP and TISPAN.

However, it also applies to any communication system based on signalling protocols that enable the negotiation, between the clients which are parties to the call, of the coding resources that they will use to transmit a multimedia session. Such a signalling protocol may, in particular, be the SIP protocol specified by RFC 3261 of the IETF.

This SIP (for “Session Initiation Protocol”) protocol enables two parties to exchange the information needed to establish a multimedia session by means of a communication network. This session may be a conventional “voice” session, but it may also comprise data, video, etc.

In order to transmit certain media, such as audio or video, the information must be encoded in a digital format. Multiple formats exist.

Some of these encodings may be better suited to certain situations. Thus, depending on whether it is desired to optimize the quality or bandwidth being used, the same coding format will not be chosen.

The communication clients have one or more coding resources which are commonly called “codecs”. These may be software modules that implement the coding algorithm, or specific or programmable electronic circuits.

In order that a multimedia session can be transmitted between two communication clients, it is naturally necessary that they share at least one common coding resource.

Prior to establishing the multimedia session, the clients negotiate the coding resource(s) to be used, by exchanging appropriate signalling messages.

Some SIP signalling messages contain data that comply with the SDP protocol, making it possible to describe the multimedia session to establish. RFC 2327 of the IETF specifies this SDP (“Session Description Protocol”). RFC 2543, entitled “An Offer/Answer Model with the Session Description Protocol (SDP)”, more particularly describes the negotiation of the encoding resources to use for establishing the multimedia session. This negotiation is based on the offer by one or both clients of the coding resources available, and choosing a common resource from among the “offered” coding resources common to both parties.

However, it appears that the way this choice operates is not precisely specified, so that each communication client manufacturer might implement a different coding resource negotiation algorithm, while remaining compatible with the IETF's specifications.

Furthermore, the choice of what codec to use is done locally by the communication clients. By definition, they do not have a global view of the communication network, and therefore cannot base their selection on the network's characteristics, such as available bandwidth, a user profile saved in a base of profiles, etc.

The technical problem that arises is improving the situation while optimizing negotiation between the communication clients. This particularly means making negotiation independent of the selection algorithm implemented by the communication clients.

To do so, the first object of the invention is a device for a communication network, comprising communication interfaces for transmitting signalling messages between a calling client and a called client. These signalling messages may contain resource information regarding the coding resources that the clients have, which are intended for establishing a communication session between these clients.

These signalling messages comprise
a message of invitation sent by the calling client to the called client,
a message of reply sent by the called client to the calling client, and
a message of acknowledgement sent by the calling client to the called client.

This device is innovative particularly in that it further has means for
deleting the resource information contained within the message of invitation before transmitting it to the called client,
determining a set of usable resources from the resource information contained within the message of invitation and within the answer message, and
selecting, if need be (meaning if the determined set includes more than one resource), a coding resource from among that set and inserting resource information regarding the selected resource is the only resource information within the answer message before transmission to the calling client, and within the message of acknowledgment before transmission to the called client.

These signalling messages may be compliant with the SIP protocol, and the resource information may be compliant with the SDP protocol.

According to one embodiment of the invention, the device may further comprise a memory provided to save the resource information contained within the message of invitation received from the called client.

According to one embodiment of the invention, it means are provided to select the resource based on the data concerning the bandwidth between the calling client and the called client. This data may, for example, be obtained from a location system or network management system.

A further object of the invention is a negotiation method for establishing a multimedia session between a calling client and a called client connected to a communication network, by exchanging signalling messages. This signalling message exchange comprises:
the calling client sending a message of invitation to the called client,
the called client sending an answer message to the calling client, and
the calling client sending a message of acknowledgment to the called client,

The inventive method is characterized in that the signalling messages are transmitted by means of a device of the communication network, and in that this device:
deletes the resource information contained within the message of invitation before transmitting it to the called client,
determines a set of usable resources from the resource information contained within the message of invitation and within the answer message, and
selects, if applicable, a coding resource from the set and inserts resource information regarding the resource as the only resource information within the answer message for transmitting it to the calling client, and within the message of acknowledgment before transmitting it to the called client.

Thus, by shifting the selection of the coding resources to use, within a device of the telecommunications network, this selection becomes independent of the algorithms which are implemented within the clients themselves.

It also becomes possible to benefit from global data made available to that device to select the coding resources to be used from among those possible.

The invention, its characteristics, and its benefits will become apparent in the following description, in connection with the attached figures.

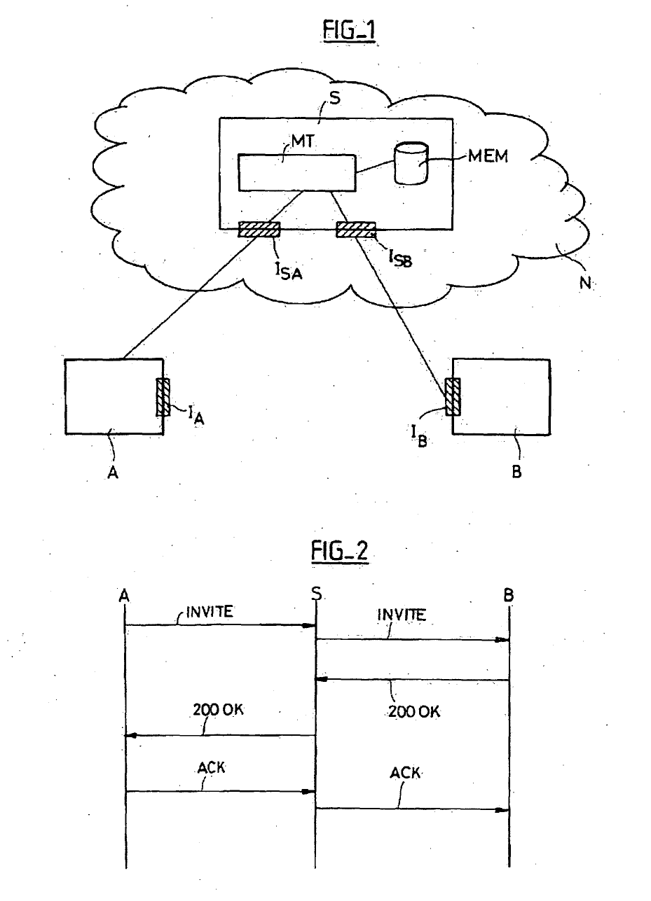

FIG. 1 schematically depicts a communication network comprising a device in accordance with the invention.

FIG. 2 depicts an exchange of signalling message in accordance with the invention.

In order to facilitate the description, we will focus only on a situation in which two communication clients negotiate a multimedia session. However, the invention may also be applied to multimedia sessions involving more than two clients.

Likewise, the term “communication client” must be understood to include not only a communication terminal, but also a content server or application server, for example. Thus, the invention may be applied to negotiating the coding resources to be used between a communication terminal and an on-demand video server.

The communication terminals may be mobile telecommunication terminals, computers equipped with telecommunications interfaces, television sets which are also equipped, personal digital assistants (or PDAs), etc.

FIG. 1 depicts two communication clients A and B connected to a communication network N. The communication clients have coding resources, respectively R_{A} and R_{B}, and communication interfaces, respectively I_{A} and I_{B}.

These coding resources, or “codecs” enable the coding and decoding of audio or video streams to or from a digital medium. Different codecs may be available for each type of media: audio, video, etc. Some codecs are better suited to certain types of content. Thus, if the audio is voice (a telephone conversation, for example), or music, the code to be used might not be the same.

Some examples of audio codecs include: PCMU and PCMA specified by the G.711 standard of the ITU-T, the G.723 standard of the ITU-T, iLBC, AMR, AMR-WB, etc.

Video codecs include: the H.261 standard, MPV (video part of MPEG-1 or MPEG-2 format), etc.

Each codec may be configured, thereby forming many possible coding resources.

The communication clients also have communication interfaces. These interfaces enable them to send data packets over the communication network N. This data may carry not only multimedia sessions, but also signalling messages, particularly in accordance with the SIP protocol.

The communication network N comprises a device S. This device may be a “SIP proxy”. As part of an IMS architecture (“IP Multimedia Subsystem”), this proxy may be a CSCF function (“Call Session Control Function”).

It also possesses communication interfaces I_{SA} and I_{SB} which enable it to send and receive data packets carrying multimedia sessions and signalling messages. In the simplified example in FIG. 1, the only objects depicted are an interface I_{SA} enabling it to communicate with the client A and an interface I_{SB} enabling it to communicate with the client B.

In the example depicted in FIG. 1, it is assumed that the client A is the calling client and the client B is the called client.

The client A therefore sends a message of invitation to the client B. This message of invitation may be an “INVITE” SIP message, as depicted in the diagram in FIG. 2.

In a way known in and of itself, this “INVITE” message contains the data in accordance with the SDP protocol. A simplified example of such an “INVITE” message is given below. The SDP data starts with the line “v=0”.

INVITE sip:olivier@172.27.204.168 SIP/2.0

CSeq: 1000 INVITE

To: sip:olivier@live-ims.com

Max-Forwards: 67

Content-Type: application/sdp

Call-ID: 0017a4f4fabf-8248031671927676087

From: <sip:olivier.durecu@alcatel-lucent.com>;tag=20017a4f4fabf-824803167-817-171438208

Contact: <sip:172.25.70.3:5660;transport=UDP>

Content-Length: 319

v=0

o=null 1234567890 1234567891 IN IP4 172.27.204.168

s=conversation

i=conversation

c=IN IP4 172.27.204.168

t=0 0

m=audio 4760 RTP/AVP 97 98 0 8

a=rtpmap:97 AMR/16000

a=rtpmap:98 AMR-WB/8000

a=rtpmap:0 PCMU/8000

a=rtpmap:8 PCMA/8000

a=sendrecv

The data in SDP format makes it possible to describe the requested session. In this example, it is an audience session.

The SDP data also contains resource information. This information describes the coding resources which the communication client A has. In this example, it therefore has four audio codecs: AMR, AMR-WB, PCMU and PCMA.

This “INVITE” message is received by the device S via its interface I_{SB}. It is then processed by means MT which that device has.

According to the invention, these means MT delete at least the resource information contained within this incoming message of invitation, then transmit it to the client B via the communication interface I_{SB}.

All of the SDP data may be deleted.

The device S, however, saves the deleted resource information in order to be able to use it later. This information may be stored within a memory MEM.

An example of a message of invitation retransmitted to the client B is given below:

INVITE sip:olivier@172.27.204.168 SIP/2.0

CSeq: 1000 INVITE

To: sip:olivier@live-ims.com

Max-Forwards: 67

Content-Type: application/sdp

Call-ID: 0017a4f4fabf-8248031671927676087

From: <sip:olivier.durecu@alcatel-lucent.com>;tag=20017a4f4fabf-824803167-817-171438208

Contact: <sip:172.25.70.3:5660;transport=UDP>

Content-Length: 0

The client B receives this message of invitation via its communication interface I_{B}.

Its answer may depend on a decision by the client's user, and particularly whether or not it is accepting the call. Assume that the call is accepted by the communication client B et that it then replies with a “200 OK” answer message in accordance with the SIP protocol and with RFC 2543 of the IETF.

Since this message of invitation does not include any resource information, the “200 OK” answer message must include an “offer” of resources within the meaning of RFC 3264. Such behaviour is normal, and is particularly illustrated by RFC 3725 entitled “Best Current Practices for Third Party Call Control (3pcc) in the Session Initiation Protocol”.

The “200 OK” answer message therefore contains resource information regarding the coding resources that the communication client has B.

An example “200 OK” answer message is given below:

SIP/2.0 200 OK

To: <sip:olivier@live-ims.com>;tag=47fb1a3f-1207645032125630-069

From: <sip:olivier.durecu@alcatel-lucent.com>;tag=20017a4f4fabf-824803167-817-171438208

Call-ID: 0017a4f4fabf-8248031671927676087

CSeq: 1000 INVITE

Contact: olivier<sip:olivier@172.27.204.168>

Content-Type: application/sdp

Content-Length: 178

v=0

o=LUSIPPhone 0 0 IN IP4 172.27.204.168

s=conversation

i=conversation

c=IN IP4 172.27.204.168

t=00

m=audio 8552 RTP/AVP 0

b=AS:64

a=rtpmap:97 AMR/16000

a=rtpmap:0 PCMU/8000

a=rtpmap:8 PCMA/8000

a=sendrecv

In this example, the communication client B indicates that it has three audio coding resources R_{B}: AMR, PCMU and PCMA.

This answer message is transmitted via the communication interface I_{B} to the device S. This device receives it on its communication interface I_{SB} and processes it via its processing means MT.

The processing means therefore have resource information regarding client B, transmitted by the “200 OK” answer message, and resource information regarding client A, saved in the MEM memory.

The processing means MT are intended to determine a set of usable resources from resource information coming from the two communication clients A and B.

This set of usable resources may be formed by the set of coding resources shared by clients A and B.

This set may be empty, in which case no session can be established. The request must then be refused.

The set may also be reduced to a singleton.

If the set of usable resources includes more than one coding resource, a selection may be made by the processing means MT in order to determine a single coding resource.

This way, a coding resource is selected by the device S, and this choice is imposed on the communication clients A and B.

This selection may be performed by the means MT depending on the data available within the communication network N.

This data may particularly concern the bandwidth on the connections used for transmitting the multimedia session between the clients A and B.

This data may, for example, be obtained from a location system which can identify the type of access network through which the clients are connected. This identification may be used as a limiting factor for choosing an appropriate codec. Thus, if one of the clients is connected via a 3G mobile network, the G.711 video codecs and the audio codecs may be eliminated in favour of the AMR codec, for example.

The data may also be obtained from a network management system which may have access to (and therefore provide) information on the network's congestion and on the available time and bandwidth.

Other apparatuses may also be used to provide data on the bandwidth. The device S may also use other criteria than the deadline or bandwidth for selecting a codec from among those that are available.

In the example, the selected codec is the AMR codec, because the bandwidth available is low and the AMR codec is the least expensive in terms of bandwidth from among the available coding resources, AMR, PCMU, and PCMA.

After this election, the device S transmits the “200 OK” answer message to the calling client A, by first inserting information about the selected coding resource. Such an answer message may, for example, be:

SIP/2.0 200 OK

To: <sip:olivier@live-ims.com>;tag=47fb1a3f-1207645032125630-069

From: <sip:olivier.durecu@alcatel-lucent.com>;tag=20017a4f4fabf-824803167-817-171438208

Call-ID: 0017a4f4fabf-8248031671927676087

CSeq: 1000 INVITE

Contact: olivier<sip:olivier@172.27.204.168>

Content-Type: application/sdp

Content-Length: 178

v=0

o=LUSIPPhone 0 0 IN IP4 172.27.204.168

s=conversation

i=conversation

c=IN IP4 172.27.204.168

t=00

m=audio 8552 RTP/AVP 0

b=AS:64

a=rtpmap:97 AMR/16000

a=sendrecv

The communication client A receives this answer message on its communication interface, and requires it to use that particular codec for transmitting the multimedia session.

According to RFC 3261, it then answers with a message of acknowledgment “ACK”. This message of acknowledgment does not normally contain information on the coding resources.

An example of such a message is given below:

ACK sip:olivier@172.27.204.168 SIP/2.0

CSeq: 1000 ACK

To: <sip:olivier@live-ims.com>;tag=47fb1a3f-1207645032125630-069

Max-Forwards: 68

From: <sip:olivier.durecu@alcatel-lucent.com>;tag=20017a4f4fabf-824803167-817-171438208

Call-ID: 0017a4f4fabf-8248031671927676087

Content-Length: 0

This message is received by the device S on its interface I_{SB}. The processing means MT insert into this received message the information about the chosen coding resource before transmitting it to the called communication client, B.

An example message of acknowledgment ACK retransmitted to the client B may be:

ACK sip:olivier@172.27.204.168 SIP/2.0

CSeq: 1000 ACK

To: <sip:olivier@live-ims.com>;tag=47fb1a3f-1207645032125630-069

Max-Forwards: 68

From: <sip:olivier.durecu@alcatel-lucent.com>;tag=20017a4f4fabf-824803167-817-171438208

Call-ID: 0017a4f4fabf-8248031671927676087

Content-Length: 178

v=0

o=LUSIPPhone 0 0 IN IP4 172.27.204.168

s=conversation

i=conversation

c=IN IP4 172.27.204.168

t=0 0

m=audio 8552 RTP/AVP 0

b=AS:64

a=rtpmap: 97 AMR/16000

a=sendrecv

This way, the communication clients A and B are informed of the coding resource chosen by the device S and to be used for establishing and transmitting the negotiated multimedia session

1. A device for a communication network, comprising:
communication interfaces for transmitting signaling messages between a calling client and a called client, which may contain resource information regarding the coding resources that said clients have, intended to establish a communication session between said clients, said signaling messages comprising an invite message sent by said calling client to said called client, an answer message sent by said called client to said calling client, and an acknowledgment message sent by said calling client to said called client, further having,
means for deleting the resource information contained within said invite message before transmitting to said called client, for determining a set of useable resources from resource information contained within said invite message and answer message, and for selecting, if applicable, a coding resource from among said set and inserting resource information regarding said resource as the only resource information within said answer message before transmission to said calling client, and within said acknowledgment message before transmission to said called client.

2. A device according to claim 1, wherein said signaling messages are in compliance with the SIP protocol, said invite message being an “INVITE” message, said answer message being a “200 OK” message, and said acknowledgment message being an “ACK” message.

3. A device according to claim 2, wherein said resource information is compliant with the SDP protocol.

4. A device according to claim 1, further comprising:
a memory intended to save the resource information contained within said invite message received from said calling client.

5. A device according to claim 1, wherein said means (MT) are included to select a said resource from among said set of available resources based on data regarding the bandwidth between said calling client and said called client.

6. A device according to claim 5, wherein said data regarding the bandwidth is obtained from a location system.

7. A device according to claim 5, wherein said data regarding the bandwidth is obtained from a network management system.

8. A negotiation method for establishing a multimedia session between a calling client and a called client connected to a communication network, by exchanging signaling messages, said exchange comprising:
sending, by said calling client an invite message to said called client;
sending, by said called client, an answer message to said calling client; and
sending, by said calling client an acknowledgment message to said called client, wherein said signaling messages are transmitted by means of a device of said communication network, and said device
deletes the resource information contained within the invite message before transmitting it to said called client,
determines a set of usable resources from the resource information contained within the invite message and within the answer message, and
selects, if applicable, a coding resource from among said set and inserts resource information regarding said resource as the only resource information within said answer message before transmitting it to said calling client, and within said acknowledgment message before transmitting it to said called client.

9. A communication network comprising a device according to claim 1.

10. A computer program comprising a program code capable of implementing the steps of the method according to claim 8.
